(19) United States
(12) Patent Application Publication
(10) Pub. No.: US 2017/0000592 A1
(43) Pub. Date: Jan. 5, 2017

(54) DENTAL TREATMENT CAPSULE, FORMULATION AND DEVICE

(71) Applicant: SMARTJET TECHNOLOGIES LTD, Tel-Aviv-Yafo (IL)

(72) Inventors: Pinchas SHALEV, Herzeliya (IL); Ilan GREENBERG, Haifa (IL); Michal BADASH, Even Yehuda (IL)

(21) Appl. No.: 15/113,117

(22) PCT Filed: Jan. 22, 2015
(86) PCT No.: PCT/IL2015/050075

§ 371 Date: Jul. 21, 2016

Related U.S. Application Data
(60) Provisional application No. 61/930,024, filed on Jan. 22, 2014.

(51) Int. Cl. A61C 17/028; A61C 17/02

(52) U.S. Cl. CPC A61C 17/028; A61C 17/0202; A61C 17/0205; A61C 17/0217

(57) ABSTRACT

A dental treatment apparatus is presented comprising a container adapted to contain liquid, the container comprise an opening for filling the container and for receiving through it a capsule comprising active materials, the active materials to create chemical reaction that releases gas, an assembly for providing and controlling of pressurized liquid contained in the container, and an assembly for erupting the cover of the capsule. Further presented is a method for pressurizing liquid in a container, the method may comprise providing a capsule into a capsule holding unit, wherein a tearable cover of the capsule is facing an erupting mechanism provided in the capsule holding unit, tightly locking the container, and activating the erupting mechanism by an activation mechanism to erupt the tearable cover, thereby initiating chemical reaction of active materials contained in the capsule with liquid contained in the container. Capsules according to the present invention are also presented.

### BACKGROUND

Hand-held dental treatment apparatuses known in the art, which base their operation on providing pressurized liquid as a result of chemical reaction, suffer of certain drawbacks and disadvantages such as physical size and weight too large to allow comfortable personal use, structure that prevents proper operation while holding of the apparatus in any orientation with respect to the earth gravity vector, failure to provide stable and constant pressurized liquid jet during the period of use, and most of all pressure build-up time that extends largely beyond personal acceptable duration.

### SUMMARY

A dental treatment apparatus is presented comprising a container adapted to contain liquid, the container comprise an opening adapted to fill and refill said container and to receive through it a capsule comprising active materials, the active materials to create chemical reaction that releases gas, an assembly for providing and controlling of pressurized liquid contained in the container, and an assembly for erupting a tearable cover of the capsule to allow the active materials in the capsule to begin chemical reaction with the liquid in the container to provide pressurized liquid, wherein erupting of the capsule is controllable by a user of the apparatus.

According to some embodiments assembly for erupting comprising capsule and blade holder (140) adapted to hold the capsule stable with respect to blades of the assembly for erupting a blade housing (145) comprising plurality of blades (145a) directed toward the tearable cover of the capsule, wherein the blade housing is adapted to erupt the tearable cover when activated by a user.

According to further embodiments the capsule and blade holder (140) is further adapted to allow easy release and removal of said capsule after its content is involved in chemical reaction.

According to additional or alternative embodiments eruption of the tearable cover of the capsule involves movement of said blades towards the tearable cover.

According to yet other embodiments eruption of the tearable cover of the capsule involves rotation of the capsule by the cap it is inserted into it, against a blade ring thereby causing eruption of the tearable cover.

A method according to embodiments of the present invention for erupting a capsule to produce gas for pressurizing liquid in a container comprise providing a capsule into a capsule holding unit, wherein a tearable cover of the capsule is facing an erupting mechanism provided in the capsule holding unit, tightly locking the container, and activating the erupting mechanism by an erupting activation mechanism to erupt the tearable cover, thereby initiating chemical reaction of a first and a second active materials contained in the capsule with liquid contained in the container, the chemical reaction to pressurize the liquid in said container.

### BRIEF DESCRIPTION OF THE DRAWINGS

The subject matter regarded as embodiments of the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically describes apparatus for providing pressurized liquid to clean the interior of the mouth, according to embodiments of the present invention;

FIG. 1A, depicts the apparatus of FIG. 1 during re-fill operation, according to embodiments of the present invention;

FIG. 1B depicts the apparatus of FIG. 1 after reaction initiation, according to embodiments of the present invention;

FIGS. 1C, 1D, 1E and 1F schematically describe an apparatus for providing pressurized dental treatment liquid, according to other embodiments of the present invention, from different views;

FIGS. 2A, 2B, 2C, 2D, 2E and 2F, schematically illustrate a capsule eruption mechanism according to embodiments of the present invention;

FIGS. 3A, 3B, 3C, 3D, 3E, 3F, 3G and 3H schematically illustrate a capsule eruption mechanism according to other embodiments of the present invention;

FIGS. 4A, 4B, 4C, 4D and 4E schematically illustrate exemplary capsules according to some embodiments of the present invention;

FIGS. 5A, SB, 5C and 5D are schematic illustrations of capsule eruption mechanisms blades and blade arrangements according to embodiments of the present invention;

FIGS. 6A, 6B and 6C are schematic illustrations of a capsule eruption mechanism's capsule and blade holder according to embodiments of the present invention, from different views;

FIGS. 7A, 7B and 7C are illustrative examples of capsule eruption mechanism's blade housings according to embodiments of the present invention; and

FIG. 8 is a flow diagram depicting operation of a dental care apparatus according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

According to embodiments of the present invention the well-known phenomena of the effervescence effect of the chemical reaction of certain first and second materials, such as baking soda (sodium bicarbonate) with certain other materials, such as citric acid (C₆H₈O_{7(aq)}) may be utilized in treatment of the hygienic of the mouth to achieve improved treatment results with respect to the depth of penetration of treating materials into cavities in the mouth and between the teeth and the gums. The first material may be a base with high value of pH, for example higher than 7 and the second material may be acidic with low value of pH, for example lower than 7. As is well known the chemical reaction of baking soda with citric acid is defined by:

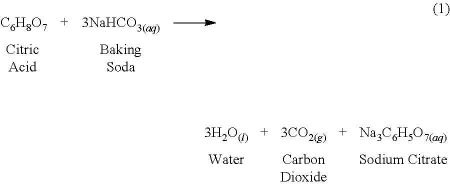

Similarly, the chemical reaction of tartaric acid with sodium bicarbonate is defined by:

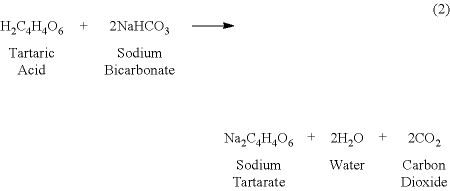

This phenomenon may be utilized, according to embodiments of the present invention, by using the gas that is released during the reaction (e.g. CO₂) to pressurize liquid in a container and to dispense that pressurized liquid for hygienic treatment of the mouth.

The effect of the use of pressurized liquid, according to embodiments of the present invention, additional to the increased mechanical impact of the pressurized liquid on removal of food residues, plaque and germs from cavities in the mouth, is the effect of ingredients of the reacting materials and/or of materials resulting from the reaction, such as baking soda granules, in providing further improved cleansing affect, acting as emery paper on surfaces in the mouth. The treating material may be, according to embodiments of the present invention, merely the granules of the first active material, e.g. baking soda or sodium bicarbonate. In some embodiments the treating material may also contain granules of one or more of materials produced during the chemical reaction. The mechanical grinding effect of the flowing granules in the pressurized liquid on the surface of the teeth acts as enhanced whitening means, leaving the teeth whiter. It will be appreciated by a person skilled in the art that other solutions may be used, which, when reacting, create effervescence effect.

It will also be apparent to a person skilled in the art that the first and/or second active materials involved in the chemical reaction causing the effervescence effect may be provided in any adequate phase or form, e.g. solid, powder, liquid or gel—as long as their chemical reaction will release gas to provide pressurized liquid and, preferably, granules. In some embodiments at least one of the first and second active materials may be provided in liquid form e.g. dissolved in water or the like. The liquid in which one of the active materials is dissolved may be used, according to embodiments of the present invention as the liquid to be pressurized.

A device designed to provide on-demand pressurized liquid for personal use of oral/dental treatment/care should be adapted to build the pressure in it within a reasonable short time, in order to be considered useful. The inventor of the invention embodiments of which are described in the current application has discovered that there is a large influence of the way the active materials, used for providing gas to pressurize the liquid, are packed, the way they are provided and come in contact with an activating material and the initial relative location of the active materials with respect to the activating material—on the time required to build a desired working pressure. One aspect having large influence on the pressure building time is the initial state of matter of the active materials. The active material(s) may be kept, initially, in solid form (or highly condensed powder), such as a tablet, which may be useful in pre-use stages (production, storage, marketing, etc.). A different initial state of matter of the active material(s) may be in granules (or ‘chiclets’ form). Another initial state of matter of the active material(s) may be in powder form (very small particles with relatively loose proximity between the particles. Such state of matter may incur difficulties in pre-use stages—need to have proper packaging, care to prevent undesired pre-use moistening of the powder, etc.

The inventor has discovered, through experiments, that for same amount of active materials, provided in one of tablet, granules or powder initial form the following reaction time applied, from activation of the chemical reaction till build of a defined amount of resulting gas:

| | Tablet | Granules | Powder |
|---|---|---|---|
| Reaction Time | Over 90 secs. | Over 30 secs. | 10 secs. |
| Packaging for a | In a container/ | Specially | Capsule |
| single activation | dispenser | designed | |
| | | dispenser | |

Based on the results of the experiments the embodiments described herein below focus on oral treatment devices adapted to receive and work with active material(s) provided in initial state of matter of powder form, packed in capsules.

The term ‘capsule’, as used throughout the present description, is meant to describe single or multi cell packaging device that is adapted to contain a defined amount of material(s) in it, to protect its content from undesired exposure to moisture of ambient air, to provide long-term storage durability and to allow fast pouring of its content when at least one of its face is torn. Accordingly at least one of its face may be made of a tearable material, such as aluminum/aluminum coated plastic foil. The capsule may have any desired external form, for example its external form may support match to use in machines, where the insertion of the capsule into the machine, holding of the capsule in the machine during its use and during its puncturing, and the removal of the used capsule after use—may dictate specific external from(s).

According to some embodiments of the present invention, at least one of the first and second active materials may be provided in powder foam packed in a sealed capsule. According to some embodiments, in case both active materials are provided in powder from and packed in a capsule, the capsule may be divided into two compartments. One compartment of the capsule may contain the first active material and the second compartment may comprise the second active material. In some embodiments both active materials may be packed together in a single space in a capsule. In such case special care shall be taken to make sure that the two active materials are in the form that will not allow commencing of chemical reaction before a desired timing. For example, the first and active materials may be in the form that requires an activating material such as water. It should be appreciated that additional materials may be added in one or both compartments. According to some embodiments, when the capsule comprises more than one compartment, one of the active materials may be provided in a powder form while the other active material may be provided in a liquid form.

According to some embodiments, the capsule may further comprise humidity absorbing materials, flavoring materials, stabilizing materials, coloring materials, aroma materials and/or dental treatment materials.

The first and second active materials may be activated to create a chemical reaction in the presence of a liquid, such as water.

According to some embodiments the activating liquid may be used also to provide treating materials to the treated area, such as disinfection, freshening and the like. The chemical features of such activating liquid may be selected as may be desired, e.g. to have no effect on the chemical reaction, to release one or more product materials that has positive effect on the treated area, as may be required, etc.

For effective operation of pressurized liquid in cleansing internal surfaces of the mouth the pressure of the pressurized liquid should preferably be within a defined range of pressure during the operation, regardless of the remaining amounts of the active materials resulting, during the chemical reaction, the effervescence. According to embodiments of the present invention the type of active materials and their initial amounts may be selected to provide, within the volume of their container, pressure within a first range of pressures, which is higher at all times than the pressure within a second range of pressures of the pressurized liquid dispensed in the mouth. The pressure created in said container may be reduced, for example using a pressure regulator, to meet the required second range of pressures thus ensuring that the pressure of the dispensed liquid into the mouth will remain substantially constant as long as the pressure in the container is higher than, or equal to the pressure of the liquid dispensed in the mouth.

According to yet further embodiments of the present invention the continuing decrease in the size of the granules of the reacting first material, e.g. baking soda, due to the chemical reaction, may be utilized for continuous refining of the level of dirt and germs removal, resulting in refined smoothness of the internal surfaces of the mouth, teeth and gums at the end of the treatment. This may last as long as the emery paper effect of the particles/granules is effective for removal and/or smoothing and/or whitening the treated surfaces. According to embodiments of the present invention the initial size of the granules of the first material may be selected for treatment with a defined level of initial dirt removal capacity and the rate of granules size reduction may be controlled to fit the specific treatment needs. It will be appreciated by a person skilled in the art that other solutions may also be used according to embodiments of the present invention which, when reacting, act on the granules of at least one active material to reduce their size during the reaction.

According to some embodiments of the present invention, the dental treatment apparatus may comprise an activating liquid container having an aperture to receive and retain a capsule; a cap to close and seal the container; and a capsule eruption mechanism.

According to some embodiments, capsule erupting mechanism may be integral to the container cap. According to other embodiments, capsule erupting mechanism may be integral to the liquid container and may be operable by an activating mechanism.

According to some embodiments, capsule erupting mechanism may comprise a capsule cover tearing or pecking element, such as blade or blades. According to some embodiments, cover tearing blade or blades may be movable. According to other embodiments, the capsule may be movable over the tearing/pecking element, such as blade or blades. According to some embodiments, erupting mechanism may comprise a plunger to apply pressure onto the capsule from one direction to cause the capsule's tearable cover to erupt.

### Capsule Content Compositions and Additives

According to embodiments of the present invention the effervescent producing materials may be provided in powder form, which may further contain required additive materials for achieving required treatment goals as is described in details herein below. The effervescent producing materials may be contained in a capsule. According to some embodiments, the effervescent producing materials may be contained in a single compartment of the capsule. According to other embodiments, each effervescence producing material may be contained in separate compartment of the capsule, and the materials may be allowed to compose only when activation is required. The term ‘effervescence producing materials’, as used throughout this specification, relates to material or materials that are adapted to participate in a chemical reaction, where not all of the materials contained in the capsule necessarily adapted to participate in that chemical reaction. Additionally to treatment effects according to the present invention that were mentioned above, capsules made according to embodiments of the invention may comprise, additionally to the first and/or second active materials, materials for treating mouth interim surfaces, for providing odors, for providing vitamins, for providing disinfecting materials, for grinding and whitening the teeth, etc. The amount of each of the ingredients in a capsule, as well as their order of release, their level of solubility and other respective features may be set so as to fulfill the treatment goals it is designed for, as is explained in details below.

According to one embodiment the content of a capsule may include the ingredients listed in the table below:

Regular Option (Formula No 1)

| INCI Name of | Trade | | 7 gr for one |
|---|---|---|---|
| Ingredients | Name | Content % | Treatment |
| Sodium Bicarbonate | Sodium | 45.25% | 3.167659703 |
| | Bicarbonate | | |
| Citric acid | Citric acid | 45.25% | 3.167659703 |
| Sodium Fluoride | Sodium | 2.50% | 0.17527717 |
| | Fluoride | | |
| Sodium Saccharin | Sodium | 1.00% | 0.069688513 |
| | Saccharin | | |
| Flavor | Liquid | 1.00% | 0.069688513 |
| | Peppermint | | |
| Meltodextrin | Meltodextrin | 5.00% | 0.350026397 |

| | | |
|---|---|---|
| Total | 100.00% | 7 |

According to another embodiment, the formula of the capsule may include instead of citric acid, Effer Citric, which is citric acid coated with sodium citrate. The coating of the citric acid may serve as an insulator of the acid from the ambient humidity and prevent an undesired initiation of the reaction between the active materials in the capsule. The coating thus prolongs the shelf life of the capsule even when the active materials are contained in a common compartment of the capsule. An exemplary formula containing Effer Citric is shown in the table below:

Coated Citric 1 Option (Formula No 2)

| | | | 7 gr for one |
|---|---|---|---|
| INCI Name of Ingredients | Trade Name | Content % | Treatment |
| Sodium Bicarbonate | Sodium | 45.25% | 3.167659703 |
| | Bicarbonate | | |
| Citric acid Coated Sodium | Effer Citric | 45.25% | 3.167659703 |
| Citrite | | | |
| Sodium Fluoride | Sodium Fluoride | 2.50% | 0.17527717 |
| Sodium Saccharin | Sodium Saccharin | 1.00% | 0.069688513 |
| Flavor | Liquid | 1.00% | 0.069688513 |
| | Peppermint | | |
| Meltodextrin | Meltodextrin | 5.00% | 0.350026397 |

| | | |
|---|---|---|
| Total | 100.00% | 7 |

As seen in the formulation above, Meltodextrin may also be added as a humidity absorber, in addition to or instead of coating the active materials. Furthermore, sodium saccharin is also a humidity absorber and may inhibit an undesired reaction between active materials due to humidity.

Alternatively, the citric acid may be coated with other coating materials, such as Meltodextrin, an exemplary formula may be:

Coated Citric 2 Option (Formula No 3)

| | | | 7 gr for |
|---|---|---|---|
| INCI Name of | | | one |
| Ingredients | Trade Name | Content % | Treatment |
| Sodium Bicarbonate | Sodium Bicarbonate | 45.25% | 3.167659703 |
| Citric acid Coated | Citric acid Coated | 50.25% | 3.517659703 |
| Meltodextrin | Meltodextrin | | |
| Sodium Fluoride | Sodium Fluoride | 2.50% | 0.17527717 |
| Sodium Saccharin | Sodium Saccharin | 1.00% | 0.069688513 |
| Flavor | Liquid Peppermint | 1.00% | 0.069688513 |

| | | |
|---|---|---|
| Total | 100.00% | 6.999973603 |

Where the Sodium Saccharin may also be used as a humidity absorber and may inhibit an undesired reaction between active materials due to humidity

According to some embodiments, the base active material may be coated, instead of the acid. For example, according to some embodiments, sodium bicarbonate may be replaced with Effersoda, which is coated sodium bicarbonate, as shown in the exemplary composition below:

Effersoda Regular Option (Formula No 4)

| INCI Name of | | | 7 gr for one |
|---|---|---|---|
| Ingredients | Trade Name | Content % | Treatment |
| Effersoda | Effersoda | 45.25% | 3.167659703 |
| Citric acid | Citric acid | 45.25% | 3.167659703 |
| Sodium Fluoride | Sodium | 2.50% | 0.17527717 |
| | Fluoride | | |
| Sodium Saccharin | Sodium | 1.00% | 0.069688513 |
| | Saccharin | | |
| Flavor | Liquid | 1.00% | 0.069688513 |
| | Peppermint | | |
| Meltodextrin | Meltodextrin | 5.00% | 0.350026397 |

| | | |
|---|---|---|
| Total | 100.00% | 7 |

In another embodiment, both the acid and the base may be coated. For example, the capsule may contain the following composition:

Effersoda and EfferCitric Option (Formula No 5)

| | | | 7 gr for one |
|---|---|---|---|
| INCI Name of Ingredients | Trade Name | Content % | Treatment |
| Effersoda | Effersoda | 45.25% | 3.167659703 |
| Citric acid Coated | Effer Citric | 45.25% | 3.167659703 |
| Sodium Citrite | | | |
| Sodium Fluoride | Sodium Fluoride | 2.50% | 0.17527717 |
| Sodium Saccharin | Sodium Saccharin | 1.00% | 0.069688513 |
| Flavor | Liquid | 1.00% | 0.069688513 |
| | Peppermint | | |
| Meltodextrin | Meltodextrin | 5.00% | 0.350026397 |

| | | |
|---|---|---|
| Total | 100.00% | 7 |

Other alternatives compositions are shown in the following tables:

Effersoa and Coated Citric 2 Option (Formula No 6)

| | | | 7 gr for |
|---|---|---|---|
| INCI Name of | | | one |
| Ingredients | Trade Name | Content % | Treatment |
| Effersoda | Effersoda | 45.25% | 3.167659703 |
| Citric acid Coated | Citric acid Coated | 50.25% | 3.517659703 |
| Meltodextrin | Meltodextrin | | |
| Sodium Fluoride | Sodium Fluoride | 2.50% | 0.17527717 |
| Sodium Saccharin | Sodium Saccharin | 1.00% | 0.069688513 |
| Flavor | Liquid Peppermint | 1.00% | 0.069688513 |

| | | |
|---|---|---|
| Total | 100.00% | 6.999973603 |

Karmat ™ Soda Option (Formula No 7)

| | | | 7 gr for |
|---|---|---|---|
| | | | one |
| INCI Name of Ingredients | Trade Name | Content % | Treatment |
| Sodium Bicarbonate Coated | Karmat ™ Soda | 50.25% | 3.517659703 |
| Meltodextrin | | | |
| Citric acid | Citric acid | 45.25% | 3.167659703 |
| Sodium Fluoride | Sodium Fluoride | 2.50% | 0.17527717 |
| Sodium Saccharin | Sodium Saccharin | 1.00% | 0.069688513 |
| Flavor | Liquid | 1.00% | 0.069688513 |
| | Peppermint | | |

| | | |
|---|---|---|
| Total | 100.00% | 7 |

Karmat Soda and Coated Citric acid Option 1 (Formula No 8)

| | | | 7 gr for |
|---|---|---|---|
| | | | one |
| INCI Name of Ingredients | Trade Name | Content % | Treatment |
| Sodium Bicarbonate Coated | Karmat Soda | 50.25% | 3.517659703 |
| Meltodextrin | | | |
| Citric acid Coated Sodium | Effer Citric | 45.25% | 3.167659703 |
| Citrite | | | |
| Sodium Fluoride | Sodium Fluoride | 2.50% | 0.17527717 |
| Sodium Saccharin | Sodium Saccharin | 1.00% | 0.069688513 |
| Flavor | Liquid | 1.00% | 0.069688513 |
| | Peppermint | | |

| | | |
|---|---|---|
| Total | 100.00% | 7 |

Karmat Soda and Coated Citric acid Option 2 (Formula No 9)

| | | | 7 gr for |
|---|---|---|---|
| | | | one |
| INCI Name of Ingredients | Trade Name | Content % | Treatment |
| Sodium Bicarbonate Coated | Karmat Soda | 47.75% | 3.3425 |
| Meltodextrin | | | |
| Citric acid Coated | Citric acid Coated | 47.75% | 3.3425 |
| Meltodextrin | Meltodextrin | | |
| Sodium Fluoride | Sodium Fluoride | 2.50% | 0.17527717 |
| Sodium Saccharin | Sodium Saccharin | 1.00% | 0.069688513 |
| Flavor | Liquid | 1.00% | 0.069688513 |
| | Peppermint | | |

| | | |
|---|---|---|
| Total | 100.00% | 6.999654197 |

It should be appreciated that the examples presented above merely serve as exemplary solutions and other formulation may be used. For example, other coating materials may be used, other or additional humidity absorbers may be used. A variety of flavors may be used and different additives may be added, such as coloring materials, stabilizing materials, dental treatment materials arid the like. It should be further appreciated that other or additional active materials may be used as long as the active materials release gas when they react.

According to one embodiment of the present invention, a single gas charged active material, such as zeolite and/or activated carbon, may be used for pressurizing the liquid. The gas charged active material, may release gas (e.g. CO₂) when the gas charged active material interacts with an activating liquid, such as water. It should be appreciated that in addition to the gas charged active material, a capsule containing it further may contain additives, such as dental treatment materials, flavor materials, aromatic materials, stabilizing materials, humidity absorbers, coloring materials and the like.

According to some embodiments, coloring materials may serve as indicators to indicate to user that the solution is ready for use. For example, the capsule may contain in addition to the active materials and the other additives a coloring material that changes its color from one color to another when the pH of the solution reaches a defined level. Exemplary coloring materials, that may serve as indicators according to embodiments of the present invention are listed in the following table:

| | E - | |
|---|---|---|
| Raw Material | No. | Color change - Function |
| Beet juice | E162 | from red at acidic pH to purple at basic pH |
| Blackberries, | E163 | from red at acidic pH to purple at basic pH |
| black currants, | | |
| and black | | |
| raspberries | | |
| Cherries juice | E163 | from red at acidic pH to blue and purple at |
| | | basic pH |
| Curry contains | E163 | changes from yellow at pH 7.4 to red at pH 8.6 |
| the pigment | | |
| curcumin | | |
| Geraniums | E163 | hanges from orange-red in an acidic solution to |
| contain the | | blue in a basic solution |
| anthocyanin | | |
| pelargonin | | |
| Blue grapes | E163 | changes from deep red in an acidic solution to |
| | | violet in a basic solution |
| Red onion | E163 | changes from pale red in an acidic solution to |
| | | green in a basic solution. |
| Red cabbage juice | E163 | Very acidic solutions will turn anthocyanin a |
| | | red color. Neutral solutions result in a purplish |
| | | color. Basic solutions appear in greenish- |
| | | yellow. |
| β-Carotene | E160 | yellow to orange |
| Canthaxanthin | E161 | peach to reddish-orange |
| Carmine | E120 | orange to red or purple |
| Elderberry | | peach to grape |

### Compositions of Capsule's Content

The choice of ingredients for capsules' content according to embodiments of the present invention, may be deducted both by the requirement of the manufacturing process and the necessity of making a preparation which dissolves in water. The required ingredients, according to one embodiment, are at least one acid and at least one base. The base should release, according to embodiments of the present invention, gas, such as carbon dioxide, upon reaction with the acid. Examples of such acids may include tartaric acid and citric acid. Examples of bases include sodium carbonate, potassium bicarbonate, sodium bicarbonate.

According to another embodiment, a single gas charged active material, such as zeolite and/or activated carbon, may be used. The gas charged active material, may release gas (e.g. CO₂) when the gas charged active material interacts with an activating liquid, such as water.

Capsules according to embodiments of the present invention may further comprise humidity absorbing materials, to prevent or delay the initiation of a reaction between the active materials due to ambient humidity and to prevent undesired gas release from a gas charged active material, such as zeolite. The capsule may further be sealed by hermetic tearable cover. Effervescence producing materials may be prepared from a combination of citric and tartaric acid or may be prepared from a single acid. Effervescence producing materials may include the following ingredients, which may actually produce the effervescence: sodium bicarbonate, citric acid and tartaric acid. When added to an activating liquid, such as water, the acid or acids and base may react to liberate gas, such as carbon dioxide, resulting in effervescence. It should be noted that any acid-base combination which results in the liberation of gas, such as carbon dioxide, can be used in place of this combination as long as the ingredients are non-toxic and are suitable for oral use.

The reaction between citric acid and sodium bicarbonate and tartaric acid and sodium bicarbonate, which results in liberation of carbon dioxide, has been shown above in formulas (1) and (2). It should be noted that it requires 3 molecules of sodium bicarbonate to neutralize 1 molecule of citric acid and 2 molecule of sodium bicarbonate to neutralize 1 molecule of tartaric acid. The proportion of acids may be varied, as long as the total acidity is maintained and the bicarbonate is completely neutralized. Usually it is desired that ratio of citric acid to tartaric acid equals 1:2 so that the desired ratio of the ingredients can be calculated as follows:

Citric acid:Tartaric acid:Sodium bicarbonate=1:2:3.44 (by weight) (3)

The United States Pharmacopeia (USP) 24 includes the following seven monographs, that may be used for capsules according to embodiments of the present invention:
1. Acetaminophen for Effervescent Oral Solution;
2. Aspirin Effervescent Tablets for Oral Solution;
3. Potassium Bicarbonate Effervescent Tablets for Oral Solution;
4. Potassium Bicarbonate and Potassium Chloride for Effervescent Oral Solution;
5. Potassium Bicarbonate and Potassium Chloride Effervescent Tablets for Oral Solution;
6. Potassium and Sodium Bicarbonates and Citric Acid for Oral Solution; and
7. Potassium Chloride, Potassium Bicarbonate, and Potassium.

For the comfort of use of an apparatus for providing pressurized liquid for cleansing the mouth that apparatus should be of small size, comfortably hand-held, allowing the flexibility of pointing the tip that dispenses the pressurized liquid onto substantially any surface or cavity in the mouth. Preferably, the design and size of that apparatus should provide comfort for use also away from home, such as on the travel. Thus, it is required to ensure that the apparatus will be operable at any orientation with respect to the direction of earth gravity and that the orientation of the upper surface of the liquid contained in it will have substantially no effect on its operation.

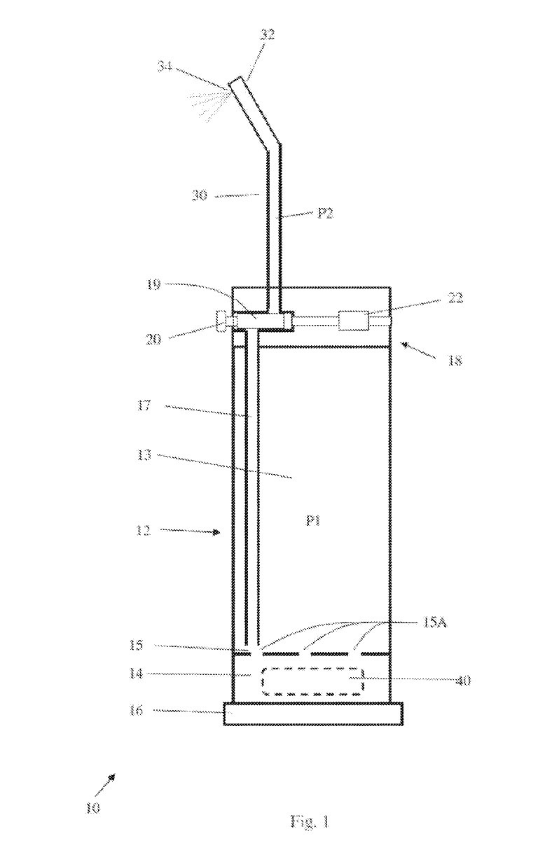

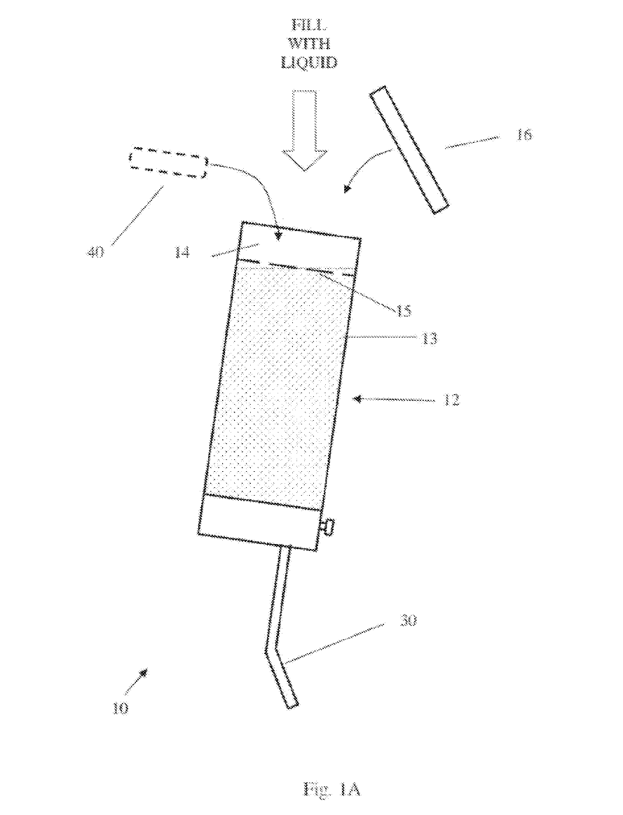

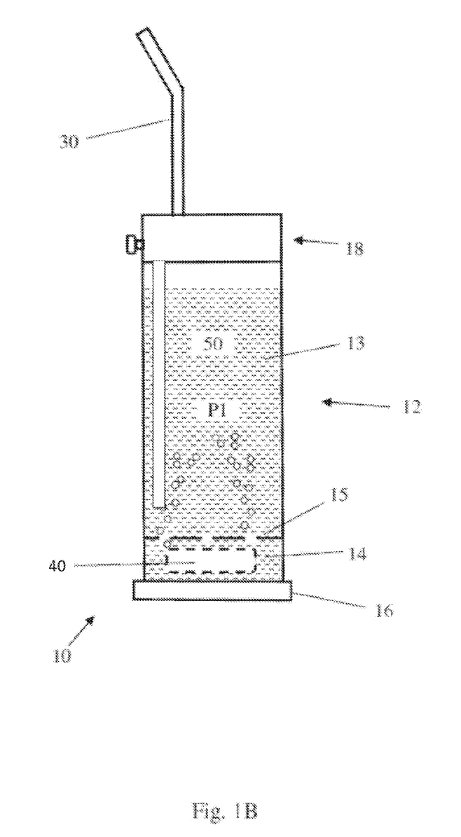

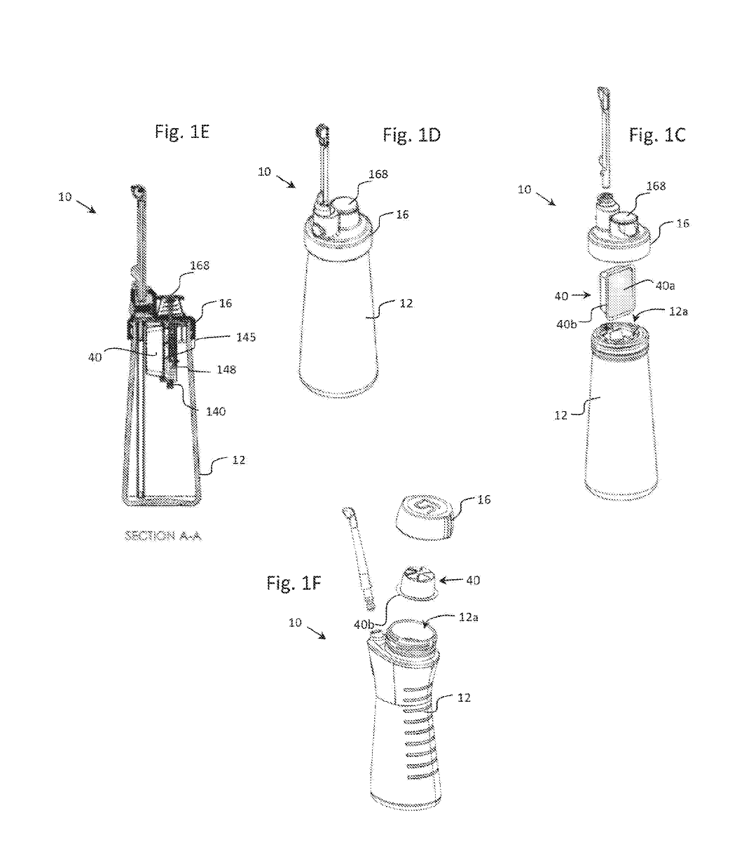

Reference is made now to FIG. 1 which schematically describes apparatus 10 for providing pressurized liquid to clean the interior of the mouth, according to embodiments of the present invention. Apparatus 10 comprise container 12 which may be partitioned by partition 15 to first space 13 and second space 14. Partition 15 is made with one or more passages 15A allowing free flow of liquid, such as water, in container 12 through partition 15. Second space 14 is adapted to contain and hold solid body, such as capsule 40.

According to some embodiments, apparatus 10 may comprise, at one end of container 12, close to space 14, a removable/openable cap 16 adapted to seal container 12 when closed and allowing filling of liquid into spaces 13 and 14 and insertion of capsule 40 into space 14 when removed or opened. Apparatus 10 further comprises, for example at the other end of container 12, liquid flow control means 18. Flow control means 18 may comprise pressure regulator and open/close assembly 19, providing step-down pressure regulation and liquid flow open/close valve. The open/close valve may be operated by pressing or releasing open/close button 20. The pressure regulator of assembly 19 receives pressurized liquid via input tube 17 at a first pressure P1 and provides pressurized liquid to dispensing tube 30 at a second pressure P2, lower than P1. Flow control means 18 may further comprise pressure safety valve 22, adapted to bleed gas and/or pressurized liquid from container 12 when the pressure inside container 12 exceeds certain level of pressure P3, higher than said first pressure P1. According to some embodiments, partition 15 may be a ring-like protrusion, extending from the inner wall of container 12 inwardly towards the center of container 12. The ring-like protrusion may form a capsule stopper 15b, so that when a capsule 40 is inserted into compartment 14, the perimeter of capsule 40 may rest upon a side of capsule stopper 15b directed towards compartment 14 and capsule stopper 15b may prevent capsule 40 from being inserted into compartment 13 of container 12.

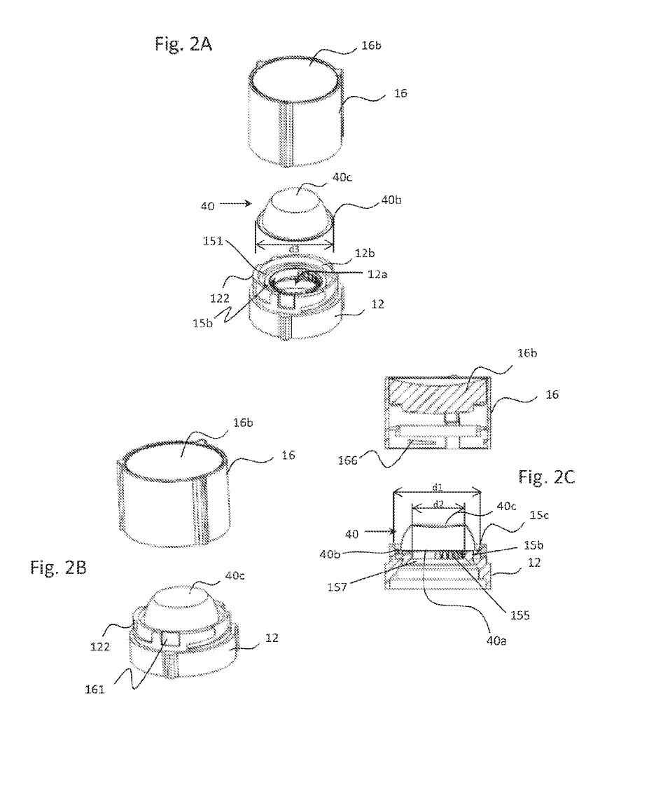

Reference is made now also to FIG. 1A, depicting apparatus 10 during re-fill operation, according to embodiments of the present invention. When apparatus 10 is to be prepared for operation e.g. by filling/refilling it with liquid 50 and/or by inserting new capsule 40 it may be turned so that the end of container 12 close to compartment 14 is facing up, then cap 16 may be opened and through the opening liquid 50 may be poured into container 12 to fill it to a desired amount and then capsule 40 may be placed in compartment 14 and cap 16 may be closed again. In order to control the time when effervescence starts, capsule 40 may be hermetically sealed by tearable cover 40a (in FIG. 2C) and may be erupted by capsule erupting mechanism as will be further described with reference to FIGS. 2A-2F. Tearable cover 40a may ensure that the content of capsule 40 remains insulated from liquid 50 thus preventing the beginning of chemical reaction until cover 40a is torn and the content of capsule 40 is released into liquid 50. It will appreciated to those skilled in the art that the location of a refilling opening in a container such as container 12, and the location of the cap covering the opening and its specific design may vary according to specific design requirements, as is shown, for example, in various examples herein below. The example of a refilling opening at the bottom of the container as shown in FIGS. 1A and 1B is not binding as other locations and designs may fulfill the needs of embodiments according to the present invention.

Reference is made now also to FIG. 1B, depicting apparatus 10 according to some embodiments, after it has been refilled and the chemical reaction has been activated by erupting capsule 40 and introducing capsule's content into liquid 50, bringing the pressure inside container 12 to the level of P1.

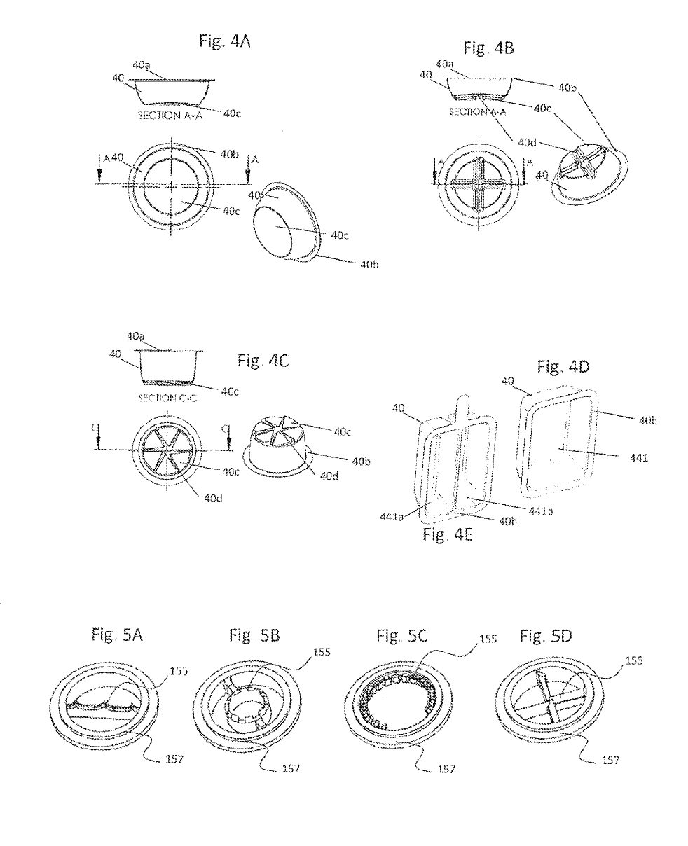

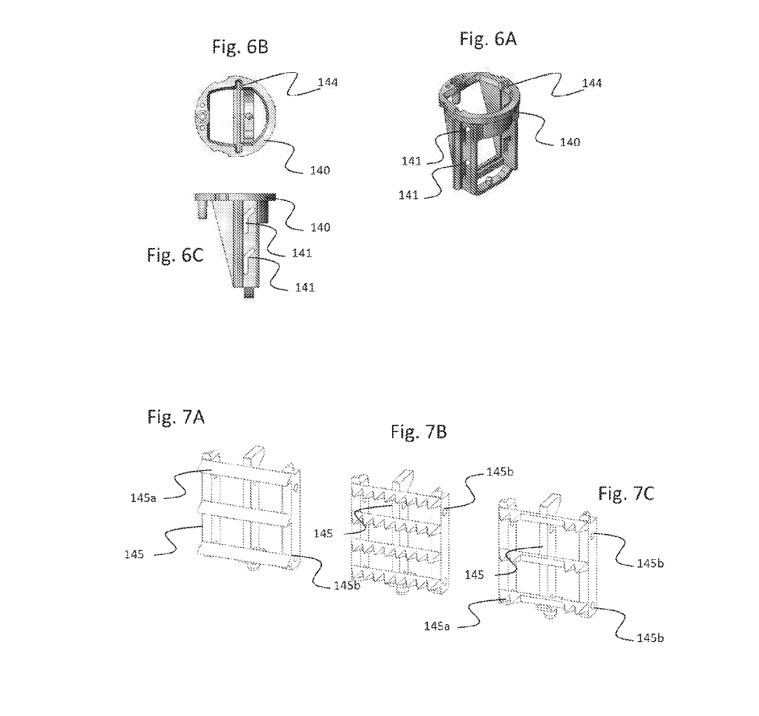

Reference is now made to FIGS. 1C, 1D and 1E depict embodiments of apparatus 10 from different views. Apparatus 10 may be filled with activating liquid 50 and loaded with capsule 40. According to the embodiments depicted in FIGS. 1C-1E, apparatus 10 may comprise a capsule eruption mechanism comprising a capsule and blade holder 140. Capsule and blade holder 140 may be fixed within opening 12a of container 12. Capsule and blade holder 140 may comprise slits (144 in FIGS. 6A and 6B) for receiving capsule lips 40b and to removably retain capsule 40 in place. According to embodiments of the present invention, when capsule 40 is inserted into capsule and blade holder 140, capsule 40 is oriented so that tearable cover 40a is directed towards blade(s) 145a in blade housing 145 (FIGS. 7A-7C). According to some embodiments, blade housing 145 is movably held within capsule and blade holder 140. Holder 140 may have guiding tracks (141 in FIGS. 6A and 6C) to guide the movement of blade housing 145 when actuated by actuator 168. Blade housing 145 may have protrusions 145b fitted to and held within guiding tracks 141. According to some embodiments, blade housing 145 may be held in an inactive position by a spring 148. When actuator 168 is actuated, for example by pressing actuator 168, blade housing 145 may be pressed towards spring 148 and spring 148 may be retracted. The movement of blade housing 145 is guided by guiding tracks 141 of holder 140 (FIG. 6C) to move blade housing 145 towards tearable cover 40a of capsule 40 in a combined movement that gradually brings the blades closer to and into tearable cover 40a and simultaneously glides the blades in direction parallel to the surface of treatable cover 40a, and to tear cover 40a to allow the content of capsule 40 to be released into activating liquid 50 in container 12. When actuator 168 is released, spring 148 may push housing 145 hack to its inactive position, along guiding tracks 141.

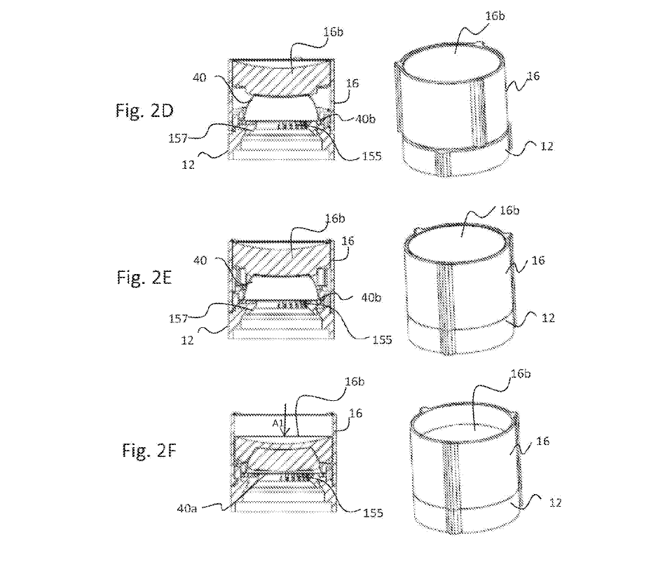

Reference is now mad to FIG. 1F which is an illustration of an apparatus 10 according to another embodiment of the present invention. Apparatus 10 may comprise a container 12 for containing activating liquid, such as water. Container 12 may have an opening 12a for filling container 12 with activating liquid and for receiving, a capsule 40. Opening 12a may have a capsule stopper (15b in FIG. 2A) to support capsule lip 40b and prevent capsule 40 from being inserted into container 12 beyond capsule stopper 15b. As will be described with further detail with reference to FIGS. 2A-3H, outer edge of container 12 may have threads corresponding to threads in an inner face of a cap 16. Apparatus 10 may further comprise a capsule eruption mechanism as is further described hereinbelow.

Reference is made now to FIGS. 2A-2F which schematically illustrate capsule eruption mechanisms according to some embodiments of the present invention. As seen in FIGS. 2A-2C, container 12 may have an opening 12a for filling container 12 with activating liquid and for inserting capsule 40. Opening 12a may have a first diameter d1 equal to or larger than the outer diameter d3 of capsule 40. Opening 12a may have a second diameter d2 smaller than outer diameter d3 of capsule 40. It should be appreciated that since diameter d2 is smaller than the outer diameter d3 of capsule 40, capsule 40 is prevented from fully entering container 12.

According to sonic embodiments diameter d2 is defined by capsule stopper 15b bulging inwardly (i.e. towards the center of opening 12a) from inner wall 12b of opening 12a. Capsule stopper 15b is adapted to engage capsule lip 40b and prevent capsule 40 from being completely inserted into container 12.

According to some embodiments, capsule stopper 15b may have a groove 15c. A sealing element, such as an O-ring seal 151 may be placed in groove 15c. It should be appreciated by those skilled in the art that seal 151 may seal container 12 when cap 16 is placed to close opening 12a and is locked in a closed position.

According to some embodiments cap 16 of container 12 may comprise a plunger 16b. Cap 16 may be adapted to close opening 12a of container 12 and may be locked in a closed position, for example by rotating cap 16 after cap 16 is placed on opening 12a, to allow bulges 122 to slide into slits 166 in cap 16. It should be appreciated that other locking mechanisms may be used as known in the art.

According to some embodiments, opening 12a may further comprise a rotation stopper 161. Rotation stopper 161 may be adapted to prevent plunger 16b from moving in an axial movement along the rotation axis of cap 16, until cap 16 is locked in a closed position.

As may be seen in FIG. 2C, capsule 40 may be inserted into opening 12a of container 12 until capsule lip 40b reaches capsule stopper 15b. Capsule 40 may be oriented to have tearable cover 40a directed towards the interior space of container 12. As seen in FIGS. 2D, 2E and 2F, after placing capsule 40 with tearable cover 40a directed towards the interior space of container 12, cap 16 may be put in place to close opening 12a. After placing cap 16 and closing container 12, cap 16 may be locked in place and may seal container 12. Locking cap 16 in place and sealing container 12 may be done by turning cap 16 in one direction (e.g. clockwise). According to some embodiments, container 12 may comprise a rotation stopper 161, to prevent axial movement of plunger 16b until cap 16 is locked, and container 12 is sealed. When cap 16 is locked in place, sealing container 12, plunger 16b may be pressed towards and against capsule base 40c. According to some embodiments of the present invention, since capsule 40 is supported only along capsule lip 40b, by capsule stopper 15b, when applying pressure to capsule base 40c, capsule 40 may collapse inwardly, and tearable cover 40a may be torn. As a result, the content of capsule 40 may be released into activating liquid 50 in container 12, and a reaction between the active materials from capsule 40, may be initiated.

According to some embodiments, container opening 12a may further comprise a blade ring 157 having at least one blade 155. As seen in FIGS. 2C-2F blade ring 157 is oriented so that blade or blades 155 are directed towards tearable cover 40a, when a capsule is inserted into container 12. According to some embodiments, the tip of blade(s) 157 may be aligned with a face of capsule stopper 15b that engages capsule lip 40b when capsule 40 is inserted into container 12. Thus, when capsule 40 is in place, the tip of blade(s) 155 is proximate to, but does not puncture, tearable cover 40a.

According to some embodiments, when plunger 16b is actuated, capsule base 40c is compressed, and thus capsule 40 is pushed against blade(s) 155, and tearable cover 40a is torn. As a result, the content of capsule 40 is released into activation liquid in container 12, and a reaction may be initiated.

Reference is now made to FIGS. 3A, 3B, 3C, 3D, E, 3F, 3G and 3H which illustrate additional capsule eruption mechanism, according to embodiments of the present invention. As seen in FIG. 3A, capsule 40 may be inserted into container 12, having tearable cover 40a directed towards the interior space of container 12. When placed in container 12, capsule 40 may be supported, along capsule lip 40b, by capsule stopper 15b. It should be appreciated that since the inner diameter of capsule stopper 15b is smaller than the outer diameter of capsule lip 40b, capsule 40 cannot be inserted into container 12 beyond capsule stopper 15b.

According to some embodiments, a blade 155 may be placed within container 12, along the inner diameter of capsule stopper 15b. Blade 155 may be pointed towards opening 12a, and having the tip of blade 155 substantially aligned with capsule stopper 15b, so that when capsule 40 is placed in container 12, the tip of blade 155 may contact tearable cover 40a, but may not puncture it.

According to some embodiments, capsule base 40c of capsule 40, may have grooves 40d which correspond to rotation protrusions 165 in inner face 16c of cap 16.

According to some embodiments of the present invention, outer edge 129 of container 12 may be threaded and inner walls of cap 16 may be threaded, to allow tightening of cap 16 to the edge of container 12, to seal opening 12a.

When capsule 40 is placed in container 12, and cap 16 is tightened to container 12, rotation protrusions 165 may fit into grooves 40d, and cause capsule 40 to rotate together with cup 16. The tightening of cup 16 to container 12, pushes capsule tearable cover 40a towards the tip of blade 155 and allows blade 155 to puncture tearable cover 40a. The rotation of capsule 40 together with cap 16 creates a substantially circular cut in tearable cover 40a along the path of blade 155 in tearable cover 40a. It should be appreciated that when tearable cover 40a is sufficiently cut (e.g. over half of the circumference of tearable cover 40a has been cut apart from capsule lip 40b) the weight of the content of capsule 40 may cause tearable cover 40a to fold outwardly towards the interior space of container 12, and the content of capsule 40 may be released into activating liquid (50 in FIG. 1) to are an effervescence reaction.

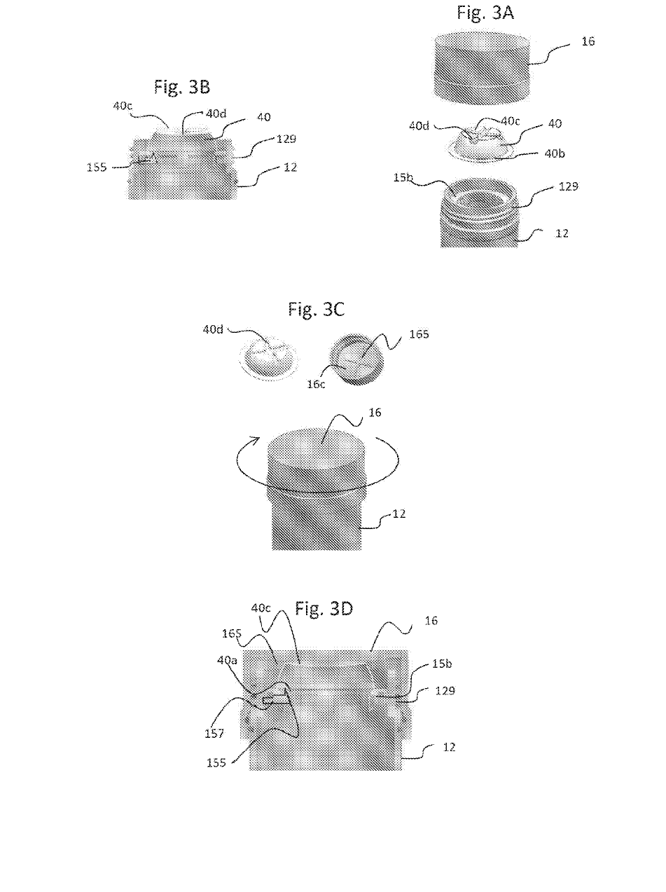

According to some embodiments, capsule base 40c may have protrusions, instead of grooves 40d, or a combination of grooves and protrusions corresponding to matching opposite grooves and/or protrusions in inner face 16c of cap 16. Additional embodiments having different cap 16 inner face 16c shapes are depicted in FIGS. 3E-3H. Additional capsule shapes and capsule base shapes according to some embodiments of the present invention are discussed with reference to FIGS. 4A-4D.

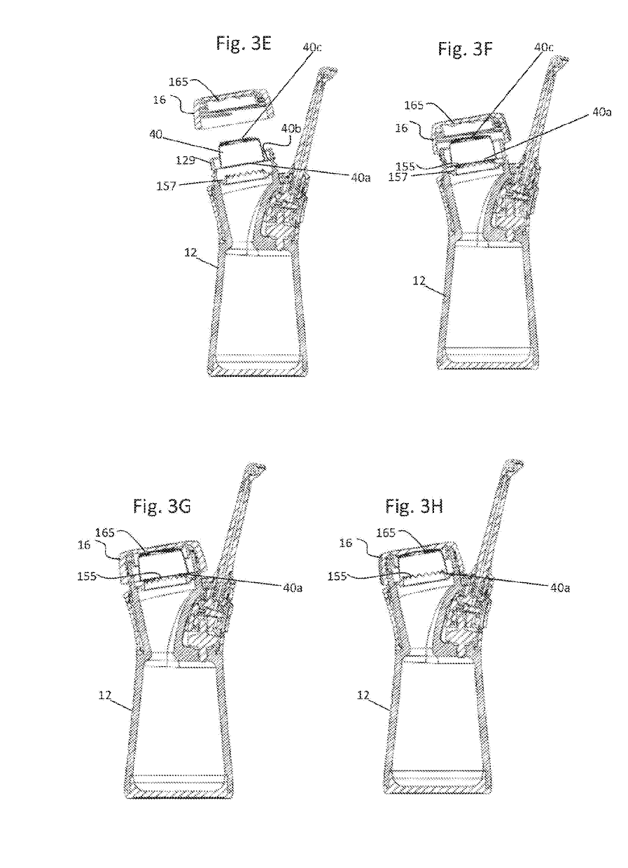

According to other embodiments, more than one blade 155 may be used. According to some embodiments a plurality of blades may be arranged on a blade ring or arrangement 157. Further blade arrangements may be used. Exemplary blades 155 and blade arrangements 157 are described with reference to FIGS. 5A-5D.

With reference to FIGS. 4A-4E, different shapes and designs of capsules 40 are presented. As seen in FIGS. 4A-4E, capsule 40 may be circular or cubical. It should be appreciated that other shapes may be used. Base 40c, may be flat, grooved, bulgy or a have both grooves and bulges. As seen in FIG. 4D capsule 40 may have one compartment 441 or as seen in FIG. 4E may have two compartments 441a, 441b. It should be understood that other number of compartments may be used. It should be further realized that capsule 40 may have an open side sealed by tearable cover (40a in FIG. 1C). Tearable cover (40a in FIG. 1C) may be made of aluminum foil, or any other tearable film cover.

Reference is now made to FIGS. 5A, 5B, 5C and 5D which illustrate different blade arrangement according to embodiments of the present invention. Blade arrangements 157 may comprise one or more blades 155, each blade 155 may have one or more tips.

FIGS. 6A, 6B and 6C depict a capsule and blade holder 140 of a capsule eruption mechanism according to some embodiments of the present invention. FIGS. 7A, 7B and 7C illustrate blade housings 145 according to embodiments of the present invention.

Capsule and blade holder 140 may comprise slits 144 for receiving capsule lips 40b and to removably retain capsule 40 in place. According to embodiments of the present invention, when capsule 40 is inserted into capsule and blade holder 140, capsule 40 is oriented so that tearable cover 40a is directed towards blade(s) 145a in blade hosing 145. According to some embodiments, blade housing 145 is movably held within capsule and blade holder 140. Holder 140 may have guiding tracks 141 to guide the movement of blade housing 145 when actuated. Blade housing 145 may have protrusions 145b fitted to and held within guiding tracks 141. The movements of blade housing 145 is guided by guiding tracks 141 of holder 140 to move blade housing 145 towards tearable cover 40a of capsule 40 and to tear cover 40a to allow the content of capsule 40 to be released to activating liquid 50 in container 12.

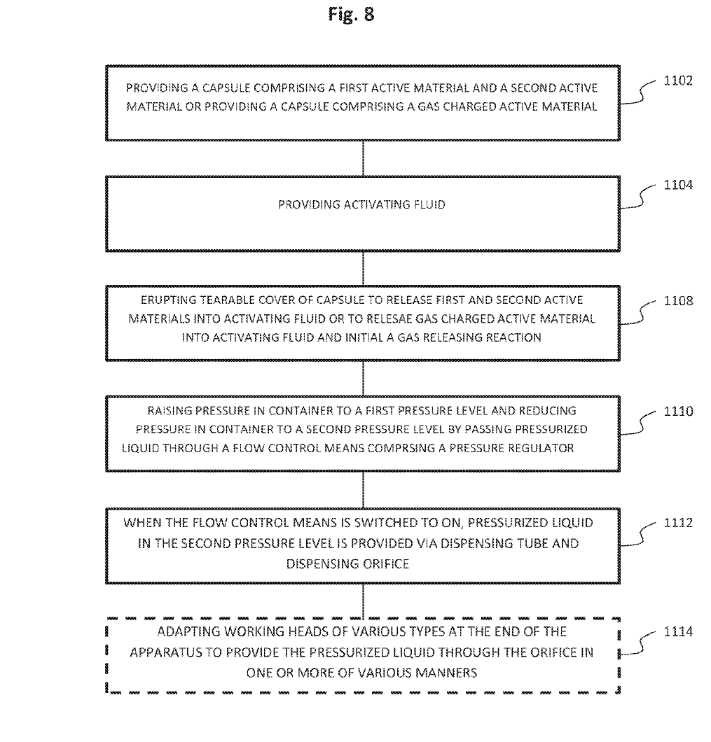

Reference is made now to FIG. 8, which is a flow diagram depicting operation of a dental care apparatus according to embodiments of the present invention.

A capsule, comprising a first active material and a second active material, is provided (block 1102). The first active material may be, for example, baking soda or sodium bicarbonate in powder form. The second active material may be citric acid or tartaric acid, contained in the capsule in powder or liquid form. The first and second active materials, contained in the capsule, may be kept in separate compartments of the capsule or may be mixed in powder form in a single compartment of the capsule. According to some embodiments of the present invention, the method may comprise providing a capsule comprising a single gas charged active material, such as charged zeolite or activated carbon.

Activating fluid, such as water or other kinds of liquid may be provided (block 1104). Optionally additives of various kinds and for various purposes may also be provided, as discussed in details above. The additives may be contained in the capsule, or added to the activating liquid.

The first and second active materials are allowed to chemically react (block 1108). The activation may begin after the container has been filled (or re-filled) with liquid, the capsule has been inserted into its compartment, the container has been closed and sealed by a cap and the capsule tearable cover has been torn and the content of the capsule has been released into the activation liquid and the liquid in the container is allowed to react with the capsule's materials. The chemical reaction liberates gas (such as carbon dioxide) through effervescent effect (block 1108). The effervescence effect causes the pressure in the container to rise to a first pressure level. When liquid in the first pressure level is provided through flow control means which comprise pressure regulator that is adapted to reduce the pressure passing the flow control means to a second pressure level (block 1110). When the flow control means is switched to ON, pressurized liquid in the second pressure level is provided via dispensing tube and dispensing orifice (block 1112). Optionally working heads of various types may be adapted at the end of the apparatus to provide the pressurized liquid through the orifice in one or more of various manners such as pulsating manner, vibrating manner, using brush, and the like (block 1114).

While certain features of the invention have been illustrated and described herein, many modifications, substitutions, changes, and equivalents will now occur to those of ordinary skill in the att. It is, therefore, to be understood that the appended claims are intended to cover all such modifications and changes as fall within the true spirit of the invention.

1. A dental treatment apparatus comprising:
a container adapted to contain liquid, said container comprise an opening adapted to fill and refill said container and to receive through it a capsule comprising active materials, the active materials to create chemical reaction that releases gas;
an assembly for providing and controlling of pressurized liquid contained in said container; and
an assembly for erupting a tearable cover of said capsule to allow the active materials in said capsule to begin chemical reaction with the liquid in said container to provide pressurized liquid,
wherein erupting of said capsule is controllable by a user of said apparatus.

2. The apparatus of claim 1 wherein said assembly for erupting comprising:
capsule and blade holder adapted to hold said capsule stable with respect to blades of said assembly for erupting; and
blade housing comprising plurality of blades directed toward said tearable cover of said capsule, wherein said blade housing is adapted to erupt said tearable cover when activated by a user.

3. The apparatus of claim 2, wherein said capsule and blade holder is further adapted to allow easy release and removal of said capsule after its content is involved in chemical reaction.

4. The apparatus of claim 2, wherein eruption of said tearable cover of said capsule involves movement of said blades towards said tearable cover.

5. The apparatus of claim 1 wherein said assembly for erupting comprising:
capsule stopper provided in said opening and adapted to support a capsule placed in said opening;
blade ring comprising at least one blade, said blade ring is provided next to said capsule stopper and having its at least one blade facing towards the external side of said opening and the tip of said at least one blade slightly aligned with the face of said capsule stopper;
wherein said tip of said at least one blade is adapted to erupt a capsule placed against said capsule stopper with its tearable cover facing said at least one blade when said capsule is pressed against said stopper.

6. The apparatus of claim 5 further comprising a cap, said cap comprising:
thread adapted to enable tight lock and seal of said opening by said cap;
plunger adapted to enable eruption of said tearable cover by pressing said capsule by said plunger against said blade ring;
wherein said cap further comprising mechanism enabling activation of said plunger only when said cap is tightly locked and sealed.

7. The apparatus of claim 5 further comprising a cap, said cap comprising:
thread adapted to enable tight lock and seal of said opening by said cap;
protrusions provided on the inner top face of said cap, said protrusions adapted to engage matching grooves made in a capsule face located against said tearable cover;
wherein when said cap is rotated to tight lock said opening, its rotation rotates a capsule inserted into it against said blade ring thereby causing eruption of said tearable cover.

8. A capsule erupting assembly comprising:
capsule and blade holder (140) adapted to hold said capsule stable with respect to blades of said assembly for erupting;
blade housing (145) comprising plurality of blades (145a) directed toward said tearable cover of said capsule, wherein said blade housing is adapted to erupt said tearable cover when activated by a user.

9. The apparatus of claim 8, wherein said capsule and blade holder (140) is further adapted to allow easy release and removal of said capsule after its content is involved in chemical reaction.

10. The apparatus of claim 8, wherein eruption of said tearable cover of said capsule involves movement of said blades towards said tearable cover.

11. (canceled)

12. A method for erupting a capsule to produce gas for pressurizing liquid in a container comprising:
providing a capsule into a capsule holding unit, wherein a tearable cover of the capsule is facing an erupting mechanism provided in said capsule holding unit;
tightly locking said container; and
activating said erupting mechanism by an erupting activation mechanism to erupt said tearable cover, thereby initiating chemical reaction of a first and a second active materials contained in said capsule with liquid contained in said container, said chemical reaction to pressurize the liquid in said container.

13. The method of claim 12 wherein the activation of said erupting mechanism is done by pressing a plunger that brings blades into contact with the tearable cover of said capsule.

14. The method of claim 12 wherein the activation of said erupting mechanism is caused by a cap of said container, said cap is adapted to press said capsule against a blade ring provided in an opening of said container when said cap is tightly locked.

15. The method of claim 14 wherein said cap is further provided with internal protrusions provided on its inner upper face, said protrusions adapted to engage matching grooves (40d) made in a capsule face located against said tearable cover, wherein when said cap is rotated to tight lock said opening its rotation rotates a capsule inserted into it against said blade ring thereby causing eruption of said tearable cover.
